(19) United States
(12) Patent Application Publication
(10) Pub. No.: US 2026/0072451 A1
(43) Pub. Date: Mar. 12, 2026

(54) WAYPOINT CORRECTION DEVICE AND WAYPOINT CORRECTION METHOD

(71) Applicant: DELTA ELECTRONICS, INC., Taoyuan City (TW)

(72) Inventors: Tzu-Yang LIN, Taoyuan City (TW); Ting-Wei CHANG, Taoyuan City (TW); Kual-Zheng LEE, Taoyuan City (TW)

(21) Appl. No.: 19/093,235

(22) Filed: Mar. 27, 2025

(30) Foreign Application Priority Data
Sep. 9, 2024 (TW) 113134106

(51) Int. Cl. G05D 1/80; G05D 1/229; G05D 1/243; G05D 1/246; G05D 105/80; G05D 109/20; G06T 7/73

(52) U.S. Cl. CPC G05D 1/80; G05D 1/229; G05D 1/2435; G05D 1/2462; G06T 7/74; G05D 2105/89; G05D 2109/20; G06T 2207/10032; G06T 2207/30252

(57) ABSTRACT

A waypoint correction device and waypoint correction method are provided. In response to a positioning signal of an unmanned aerial vehicle at a predetermined waypoint, the waypoint correction device obtains a real-time image from the unmanned aerial vehicle. The waypoint correction device calculates a feature point distribution in the real-time image based on the real-time image. The device generates an adjusted viewing angle signal based on the feature point distribution to control the unmanned aerial vehicle to rotate in place based on the adjusted viewing angle signal and capture an adjusted real-time image. The device generates a correction route based on a plurality of three-dimensional feature points, the adjusted real-time image, and a sampling number threshold to control the unmanned aerial vehicle to move from an actual position to a predetermined waypoint based on the correction route.

### CROSS-REFERENCE TO RELATED APPLICATION

This application claims priority to Taiwan Application Serial Number 113134106, filed Sep. 9, 2024, which is herein incorporated by reference in its entirety.

### BACKGROUND

### Field of Invention

The present invention relates to an unmanned aerial vehicle suitable for equipment inspection and a waypoint correction method. More particularly, the present invention relates to an unmanned aerial vehicle and a waypoint correction method that can perform waypoint correction of the unmanned aerial vehicle through visual positioning.

### Description of Related Art

In recent years, with the rapid development of unmanned aerial vehicle (UAV; also known as unmanned aerial device or drone) technology, a large number of applications related to UAVs have been proposed.

In addition, since unmanned aerial vehicles have cost and speed advantages, using unmanned aerial vehicles to perform inspection equipment tasks (e.g., safety inspection of bridge structures) is an important application. When an unmanned aerial vehicle is performing equipment inspection tasks, there may be obstacles in the inspection area or the unmanned aerial vehicle needs to take photos at a closer position (e.g., bridge inspection, building inspection, and power tower inspection).

Taking bridge inspection as an example, users can use bridge component models containing GPS information to plan routes to avoid encountering obstacles such as bridge columns and bridge guardrails during flight. However, in the prior art, not all unmanned aerial vehicles are equipped with expensive distance measurement and obstacle avoidance modules or real-time dynamic (RTK) modules. Unmanned aerial vehicles usually use GPS as their navigation system, and the potential positioning error of GPS itself may be as high as 10 meters. Therefore, the unmanned aerial vehicle may collide with obstacles such as bridge pillars due to GPS errors.

Accordingly, there is an urgent need for a waypoint correction technology that can perform a waypoint correction of unmanned aerial vehicles through visual positioning.

### SUMMARY

An objective of the present disclosure is to provide a waypoint correction device. The waypoint correction device comprises a storage and a processor, and the processor is electrically connected to the storage. The storage is configured to store a three-dimensional map, wherein the three-dimensional map comprises a plurality of three-dimensional feature points. In response to a positioning signal of an unmanned aerial vehicle being located at a predetermined waypoint, the processor obtains a real-time image from the unmanned aerial vehicle. The processor calculates a feature point distribution in the real-time image based on the real-time image. The processor generates a viewing angle adjustment instruction based on the feature point distribution to control the unmanned aerial vehicle to rotate in place based on the viewing angle adjustment instruction and capture an adjusted real-time image. The processor generates a correction route based on the plurality of three-dimensional feature points, the adjusted real-time image, and a sampling number threshold to control the unmanned aerial vehicle to move from an actual position to the predetermined waypoint based on the correction route.

Another objective of the present disclosure is to provide a waypoint correction method, which is adapted for use in an electronic apparatus. The electronic device stores a three-dimensional map, the three-dimensional map comprises a plurality of three-dimensional feature points. The waypoint correction method comprises the following steps: in response to a positioning signal of an unmanned aerial vehicle being located at a predetermined waypoint, obtaining a real-time image from the unmanned aerial vehicle; calculating a feature point distribution in the real-time image based on the real-time image; generating a viewing angle adjustment instruction based on the feature point distribution to control the unmanned aerial vehicle to rotate in place based on the viewing angle adjustment instruction and capture an adjusted real-time image; and generating a correction route based on the plurality of three-dimensional feature points, the adjusted real-time image, and a sampling number threshold to control the unmanned aerial vehicle to move from an actual position to the predetermined waypoint based on the correction route.

Another objective of the present disclosure is to provide a waypoint correction device. The waypoint correction device comprises a storage, a user interface, and a processor, and the processor is electrically connected to the storage and the user interface. The storage is configured to store a three-dimensional map, wherein the three-dimensional map comprises a plurality of three-dimensional feature points. The user interface is configured to provide a user with control over an unmanned aerial vehicle, wherein the user interface comprises a waypoint correction function activation option. In response to an activation state of the waypoint correction function activation option, the processor obtains a real-time image from the unmanned aerial vehicle. The processor generates a viewing angle adjustment instruction based on the real-time image to control the unmanned aerial vehicle to rotate in place based on the viewing angle adjustment instruction, and captures an adjusted real-time image. The processor generates a correction route based on the adjusted real-time image to control the unmanned aerial vehicle to move from the actual position to a predetermined waypoint based on the correction route.

According to the above descriptions, the waypoint correction technology (at least including the device and the method) provided by the present disclosure controls the unmanned aerial vehicle to adjust the viewing angle to capture more and more accurate real-time images with more feature points by actively analyzing the distribution of feature points of real-time images. Next, the waypoint correction technology provided by the present disclosure can generate a corrected route based on the pre-stored three-dimensional feature points and the adjusted real-time image to control the unmanned aerial vehicle to move to the correct predetermined waypoint based on the corrected route. In addition, the waypoint correction technology provided by the present disclosure can further consider the sampling times, and when the result of the projection error value is not good, the viewing angle is adjusted again to capture a new real-time image for judgment. Since the waypoint correction technology provided by the present disclosure can perform waypoint correction of unmanned aerial vehicles through visual positioning, and does not require the configuration of expensive modules, it solves the shortcomings of conventional technologies.

The detailed technology and preferred embodiments implemented for the subject disclosure are described in the following paragraphs accompanying the appended drawings for people skilled in this field to well appreciate the features of the claimed disclosure.

### BRIEF DESCRIPTION OF THE DRAWINGS

FIG. 1 is a schematic diagram depicting the structure and environment of some embodiments;

FIG. 2A is a schematic diagram depicting an inspection operation of some embodiments;

FIG. 2B is a schematic diagram depicting an inspection operation of some embodiments;

FIG. 3A is a schematic diagram depicting a three-dimensional map of some embodiments;

FIG. 3B is a schematic diagram depicting feature points of some embodiments;

FIG. 4 is a schematic diagram depicting a feature point matching of some embodiments;

FIG. 5 is a schematic diagram depicting a matching of some embodiments;

FIG. 6 is a schematic diagram depicting the operation of some embodiments;

FIG. 7 is a schematic diagram depicting a calibration operation of some embodiments;

FIG. 8 is a partial flowchart depicting the waypoint correction method of the second embodiment; and

FIG. 9 is a schematic diagram depicting a user interface of some embodiments.

### DETAILED DESCRIPTION

In the following description, a waypoint correction device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

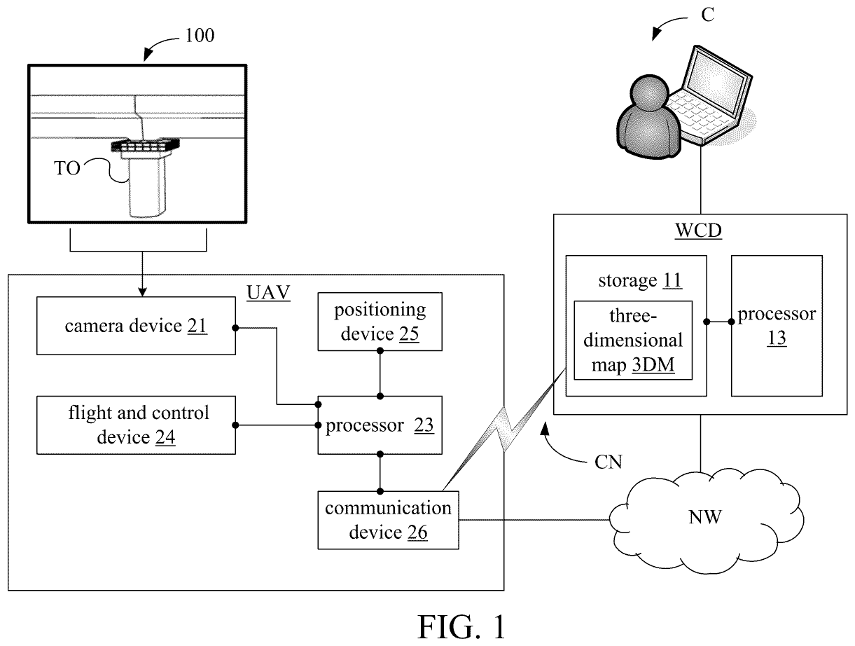

First, as shown in FIG. 1, in the application environment of the present disclosure, an unmanned aerial vehicle (UAV) equipped with a camera (single or multiple) captures a real-time image 100 corresponding to a target object TO (for example: a bridge) based on a plurality of waypoints to execute a target object TO. The present disclosure can execute a waypoint correction operation corresponding to the unmanned aerial vehicle UAV through a waypoint correction device WCD.

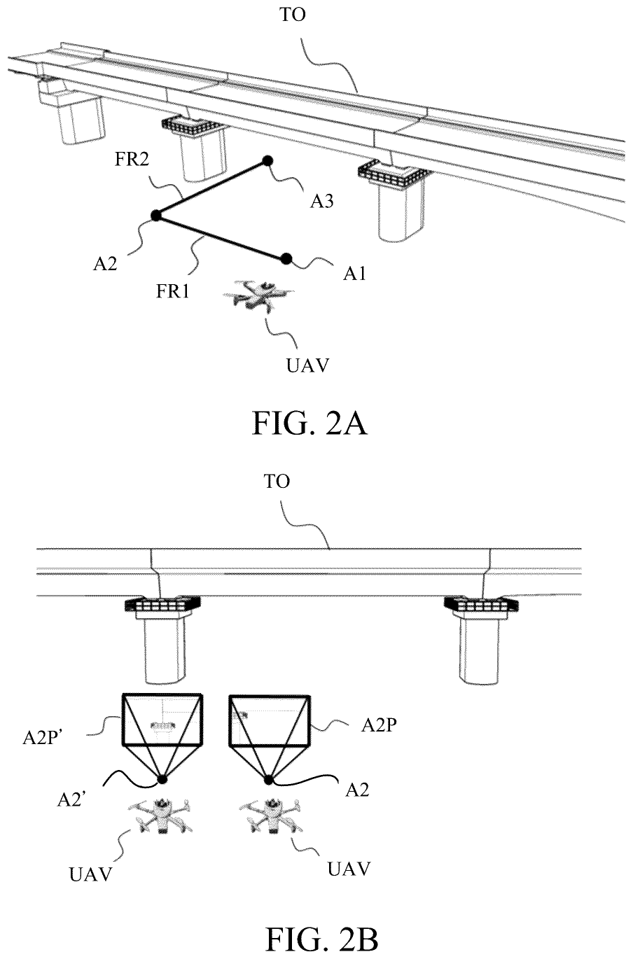

For easier understanding, please refer to FIG. 2A and FIG. 2B. As shown in FIG. 2A, the unmanned aerial vehicle UAV can receive the command of inspecting the target object TO from the waypoint correction device WCD and fly according to the pre-planned route. The inspection task includes taking real-time images at waypoints A1, A2, and A3, and each waypoint has GPS coordinates and head orientation information.

In the present example, the flight path FR1 from waypoint A1 to waypoint A2 is a completely open area and is therefore a low-risk path. The flight path FR2 from waypoint A2 to waypoint A3 may pass through the target object TO and is therefore a high risk path.

FIG. 2B is a schematic diagram showing an unmanned aerial vehicle (UAV) flying to an incorrect waypoint due to GPS error before flying a high-risk path. In the present example, the waypoint A2 is the correct waypoint where the unmanned aerial vehicle UAV wants to pass through the target object TO, and the image A2P is the image obtained by the unmanned aerial vehicle UAV at the waypoint A2. However, as shown in FIG. 2B, the actual position of the unmanned aerial vehicle UAV may be located at the wrong waypoint A2′ due to the positioning error of the GPS, and the unmanned aerial vehicle UAV obtains the wrong image A2P′ at the wrong waypoint A2′. If the flight task is still continued at the wrong waypoint, the unmanned aerial vehicle UAV may collide with the target object TO. The present disclosure can solve the aforementioned problem by executing a waypoint correction operation corresponding to the unmanned aerial vehicle UAV through a waypoint correction device WCD.

The first embodiment of the present invention is a waypoint correction device WCD, and its structure schematic diagram is depicted in FIG. 1. The waypoint correction device WCD comprises a storage 11 and a processor 13. The processor 13 is electrically connected to the storage 11.

In some embodiments, as shown in FIG. 1, the unmanned aerial vehicle UAV comprises a camera device 21, a processor 23, a flight and control device 24, a positioning device 25, and a communication device 26.

In some embodiments, the camera device 21 further comprises a camera device for inspection and a rotating component (e.g., gimbal).

In some embodiments, the flight and control device 24 comprises a power device (e.g., a rotor or a fixed wing), an inertial measurement device (e.g., an accelerometer and a gyroscope), and an environment sensing device (e.g., a barometer, thermometer, magnetometer, etc.). The positioning device 25 can be any device with a positioning function, such as a global positioning system (GPS) or a WiFi positioning device. The communication device 26 comprises an antenna device.

It shall be appreciated that the processor 13 and the processor 23 may be any of various processors, Central Processing Units (CPUs), microprocessors, digital signal processors or other computing apparatuses known to those of ordinary skill in the art. The storage 11 may be a memory, a Universal Serial Bus (USB) disk, a hard disk, a Compact Disk (CD), a mobile disk, or any other storage medium or circuit known to those of ordinary skill in the art and having the same functionality.

It shall be appreciated that FIG. 1 is for illustration only, and the present disclosure does not limit the number of the unmanned aerial vehicle UAV that can be connected to the waypoint correction device WCD.

In some embodiments, the unmanned aerial vehicle UAV can communicate with (e.g., communication link CN) the waypoint correction device WCD through the antenna in the communication device 26 to transmit relevant data (e.g., real-time images) and control signals.

In some embodiments, the waypoint correction device WCD can be set in the ground-side computer used by the user C, and the unmanned aerial vehicle UAV can transmit relevant image content generated by the unmanned aerial vehicle UAV to the waypoint correction device WCD through the network NW for processing.

In addition, in some embodiments, the waypoint correction device WCD can also be directly set in the unmanned aerial vehicle UAV and directly electrically connected to the components in the unmanned aerial vehicle UAV. Specifically, the storage and the processor in the waypoint correction device WCD are directly disposed in the unmanned aerial vehicle UAV (for example, sharing the processor 23 of the unmanned aerial vehicle UAV), and the unmanned aerial vehicle UAV directly executes all operations related to the waypoint correction device WCD in the present disclosure.

In the present embodiment, the storage 11 of the waypoint correction device WCD is configured to store a three-dimensional map 3DM, wherein the three-dimensional map 3DM comprises a plurality of three-dimensional feature points (e.g., point clouds).

It shall be appreciated that in the present disclosure, before performing a regular inspection task, the waypoint correction device WCD will first use the unmanned aerial vehicle to take pictures of the target object (i.e., the inspection target) and build a three-dimensional map (e.g., three-dimensional models) to collect images and related information of the target object to facilitate inspection planning.

For example, the waypoint correction device WCD can generate 3D point cloud information by performing a three-dimensional reconstruction operation on a plurality of inspection target images, wherein the three-dimensional reconstruction method can be implemented using the Structure from Motion (SFM) technology. Next, the waypoint correction device WCD generates a three-dimensional map 3DM based on the 3D point cloud information.

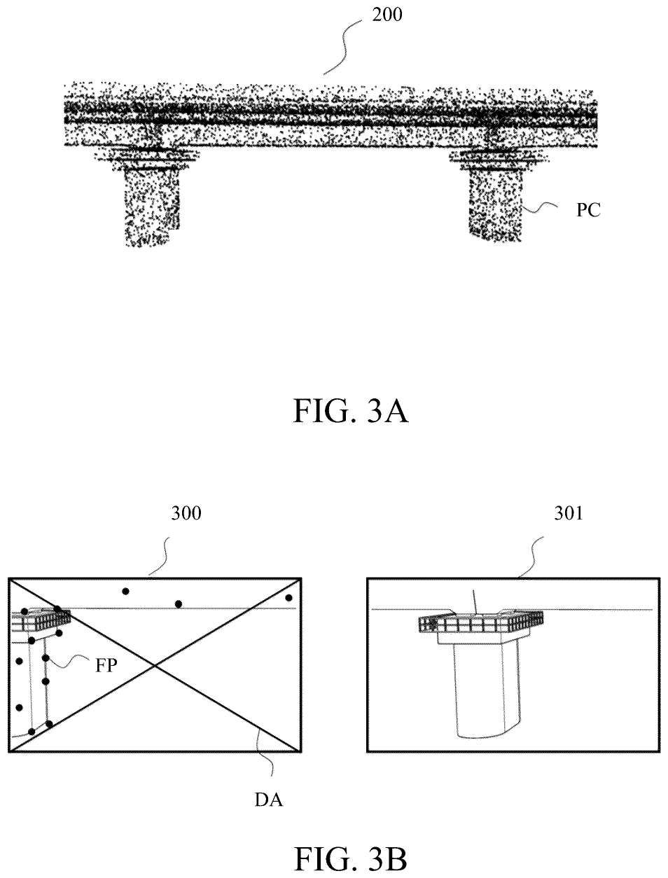

For ease of understanding, please refer to FIG. 3A which shows a three-dimensional map schematic diagram 200. In the present example, the target object is a bridge. The three-dimensional map corresponding to the target object is composed of multiple point cloud PC, and each point cloud PC contains information of three-dimensional coordinate information, color (RGB), feature value, etc.

In some embodiments, the three-dimensional map 3DM can be generated by the following operations. First, the processor 13 captures a plurality of depth images in the three-dimensional space. Next, the processor 13 stitches the depth images to generate a plurality of point clouds, wherein the point clouds are represented based on a local coordinate system. Finally, the processor 13 transforms the point clouds into a world coordinate system based on a transformation matrix to generate a three-dimensional map 3DM.

In the present embodiment, when the processor 13 determines that the unmanned aerial vehicle UAV flies to the waypoint, it starts the operation of waypoint correction. Specifically, the processor 13 obtains a real-time image from the unmanned aerial vehicle UAV in response to a positioning signal of the unmanned aerial vehicle UAV being located at a predetermined waypoint.

It shall be appreciated that due to possible occlusion or lighting problems, the real-time image captured by the unmanned aerial vehicle UAV may not have enough feature points, making the subsequent visual positioning based on the feature points inaccurate.

To solve the aforementioned problem, in the present embodiment, the processor 13 can determine whether to adjust the shooting angle of the unmanned aerial vehicle UAV by determining the feature points of the real-time image. Specifically, the processor 13 calculates a feature point distribution in the real-time image based on the real-time image. Next, the processor 13 generates a viewing angle adjustment instruction based on the feature point distribution to control the unmanned aerial vehicle UAV to rotate in place based on the viewing angle adjustment instruction and capture an adjusted real-time image.

In some embodiments, the operation of generating the viewing angle adjustment instruction comprises the following operations. First, the processor 13 selects a first region having a maximum number of feature points from a plurality of regions in the real-time image based on the feature point distribution. Next, the processor 13 generates the viewing angle adjustment instruction based on the first region. It shall be appreciated that the viewing angle adjustment instruction is configured to control the unmanned aerial vehicle UAV to move the adjustment angle toward the direction corresponding to the first region to capture the adjusted real-time image.

For easier understanding, please refer to FIG. 3B. As shown in FIG. 3B, the processor 13 divides the real-time image 300 into four regions along the diagonal line DA, and counts the number of matched feature points FP in each region, and then the unmanned aerial vehicle UAV is rotated by θ degrees (e.g., 45 degrees) toward the region with the most feature points to obtain a new positioning image. In the present example, since most of the feature points FP matched to the real-time image 300 are in the left region, the unmanned aerial vehicle UAV is rotated to the left by θ degrees to obtain a real-time image 301 of a new viewing angle.

Finally, the processor 13 can perform a waypoint correction operation based on the feature point comparison result between the adjusted real-time image and the three-dimensional feature points. Specifically, the processor 13 generates a correction route based on the three-dimensional feature points, the adjusted real-time image, and a sampling number threshold to control the unmanned aerial vehicle UAV to move from an actual position to the predetermined waypoint (i.e., the corrected waypoint) based on the correction route.

It shall be appreciated that in the present disclosure, the processor 13 can pre-set a sampling number threshold (for example, 3 times). When the projection error value calculated by the processor 13 is not good, the processor 13 can control the unmanned aerial vehicle UAV to capture the real-time image from a new viewing angle again (i.e., samples again) until the sampling number threshold is reached.

In some embodiments, the operation of generating the correction route comprises the following operations. First, in response to obtaining the adjusted real-time image from the unmanned aerial vehicle UAV, the processor 13 performs a feature point matching operation based on the adjusted real-time image and the three-dimensional feature points of the three-dimensional map to generate a plurality of first feature point pairs and a first projection error value corresponding to the adjusted real-time image. Next, in response to the first projection error value being lower than a projection threshold or a resampling number being greater than the sampling number threshold, the processor 13 calculates the actual position of the unmanned aerial vehicle UAV based on the first feature point pairs. Finally, the processor 13 generates the correction route based on the actual position, wherein the processor controls the unmanned aerial vehicle UAV to move from the actual position to the predetermined waypoint based on the correction route.

In some embodiments, the feature point matching operation comprises the following operations. First, the processor 13 calculates a plurality of plane feature points in the adjusted real-time image. Next, the processor 13 compares the plurality of plane feature points and the three-dimensional feature points to generate the first feature point pairs, wherein each of the first feature point pairs comprises one of the plane feature points and one of the three-dimensional feature points.

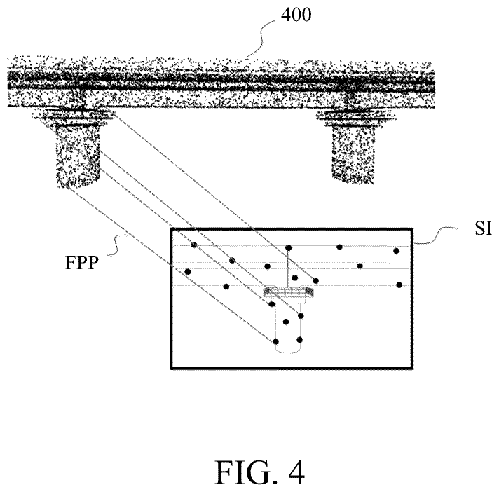

It shall be appreciated that the goal of feature point matching is to pair two feature point groups from different sources and find each feature point pair consisting of two feature points. For example, a Brute-Force Matcher method may be used to compare whether feature points in two different feature point groups correspond to the same position in space. For easier understanding, please refer to FIG. 4. FIG. 4 is a schematic diagram 400 of feature point matching between a streaming image of an unmanned aerial vehicle (UAV) and the three-dimensional feature points (e.g., point clouds) in a three-dimensional map. In the present example, the processor 13 compares the streaming image SI of the unmanned aerial vehicle UAV and all the feature points on the three-dimensional map. When the feature descriptors of two points meet the matching condition, a feature point pair FPP is formed.

In some embodiments, the operation of generating the first projection error value comprises the following operations. First, the processor 13 calculates a transfer matrix based on the three-dimensional feature points in the first feature point pairs and a plurality of corresponding plane feature points, wherein the transfer matrix is configured to transfer a three-dimensional coordinate in the three-dimensional map to one of a plurality of plane coordinates in the adjusted real-time image. Next, the processor 13 transforms the three-dimensional feature points to the plane coordinates of the adjusted real-time image based on the transfer matrix to generate a plurality of reprojection coordinates. Finally, the processor 13 compares the reprojection coordinates and the corresponding plane feature points to generate the first projection error value.

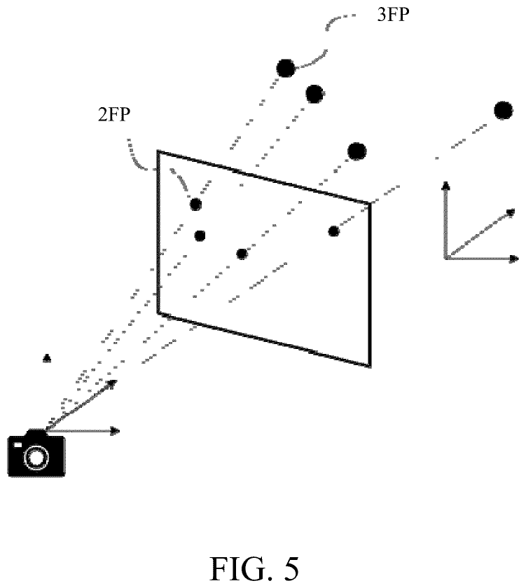

For easier understanding, please refer to FIG. 5. The present disclosure may use a PnP algorithm (Perspective-n-Point) to calculate the camera shooting pose. As shown in FIG. 5, given n sets of matching pairs of the three-dimensional feature points 3FP and the two-dimensional feature points 2FP (where n is greater than or equal to 3) and predefined camera internal orientation parameters, the pose of the current streaming image can be calculated.

For example, the camera pose is divided into two parts: a position part and a head orientation part, which can be represented by the camera's external orientation parameters, namely the rotation matrix R and the translation vector T. R is a 3×3 matrix (r₁₁˜r₃₃), and T is a 3×1 matrix (t₁˜t₃). The two-dimensional feature point set is u, v, the three-dimensional point set is x, y, z, and the camera's internal orientation parameters are composed of the two-axial focal lengths fₓ, f_{y} and the two-axial principal points cₓ, c_{y}, which form the projection equation as follows.

$$[ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}x \\ y \\ z \\ 1\end{matrix} ]$$

In addition, in the projection equation, the translation vector T can be expressed by the rotation matrix R and the camera position C as follows.

$$T = - [ R ] [ C ]$$

Therefore, the camera position (X, Y, Z) can be calculated using the following rotation matrix and translation vector.

$$[ \begin{matrix}X \\ Y \\ Z\end{matrix} ] = - {R}^{- 1} T$$

It shall be appreciated that, as shown in the following equation, the reprojection error Errorᵣₑₚᵣₒⱼ is defined as the average difference between the three-dimensional matching point projected onto the pixel plane via the projection matrix and the original two-dimensional feature point. According to the projection equation, k sets of the three-dimensional matching point sets x, y, z can be transferred to the two-dimensional point sets u′, v′, and the average error between them and the original two-dimensional feature point sets u, v is the reprojection error. For example, the recommended reprojection error threshold is 2% of the long side of the image, which is 25 px for a 1280×720 image.

$${Error}_{reproj} = \frac{{\sum }_{1}^{k} [ \begin{matrix}{u}^{′} \\ {v}^{′}\end{matrix} ] - [ \begin{matrix}u \\ v\end{matrix} ]}{k}$$

In some embodiments, the processor 13 can control the unmanned aerial vehicle UAV to recapture the adjusted real-time image based on the new adjustment angle instruction. Specifically, in response to the first projection error value being higher than the projection threshold and the resampling number being lower than the sampling number threshold, the processor 13 generates a new view angle adjustment instruction based on the feature point distribution of the adjusted real-time image to control the unmanned aerial vehicle UAV to capture the adjusted real-time image again based on the new view angle adjustment instruction.

In some embodiments, to avoid performing too many viewing angle adjustment operations, when the resampling number is greater than the sampling number threshold, the processor 13 does not continue to adjust the viewing angle, but calculates the actual position based on the current information.

Specifically, the processor 13 generates a plurality of second feature point pairs and a second projection error value corresponding to the adjusted real-time image. Next, in response to the second projection error value being lower than the projection threshold or the resampling number being greater than the sampling number threshold, the processor 13 calculates the actual position of the unmanned aerial vehicle UAV based on the second feature point pairs, and does not generate the viewing angle adjustment instruction.

In some embodiments, when the signal strength of the unmanned aerial vehicle UAV is low, the processor 13 will actively increase the frequency of obtaining real-time images from the unmanned aerial vehicle UAV to increase the frequency of correcting the route.

Specifically, in response to a signal strength of the positioning signal being lower than a strength threshold, the processor 13 generates a control signal, wherein the control signal is configured to control the unmanned aerial vehicle UAV to increase a capture frequency of capturing the real-time image, and the processor 13 increases a receiving frequency of obtaining the real-time image from the unmanned aerial vehicle UAV.

In some embodiments, when the unmanned aerial vehicle UAV is closer to the target object, the processor 13 will actively increase the frequency of obtaining real-time images from the unmanned aerial vehicle UAV to increase the frequency of correcting the route.

Specifically, in response to a distance of the predetermined waypoint and a target object being less than a distance threshold, the processor 13 generates a control signal, wherein the control signal is configured to control the unmanned aerial vehicle UAV to increase a capture frequency of capturing the real-time image, and the processor 13 increases a receiving frequency of obtaining the real-time image from the unmanned aerial vehicle UAV.

In some embodiments, the waypoint correction device WCD may further comprise a user interface controlled by the user. The user interface may be any device that can interact with the user. Specifically, the user interface is configured to receive a flag value corresponding to the predetermined waypoint. In response to the positioning signal of the unmanned aerial vehicle UAV being located at the predetermined waypoint, the processor 13 determines whether to generate a control signal based on the flag value, wherein the control signal is configured to control the unmanned aerial vehicle UAV to capture the real-time image.

Taking FIG. 2A as an example, the user can set the flag values of the waypoint A2 and the waypoint A3, and the processor 13 performs the waypoint correction operation only at the waypoint A2 and the waypoint A3.

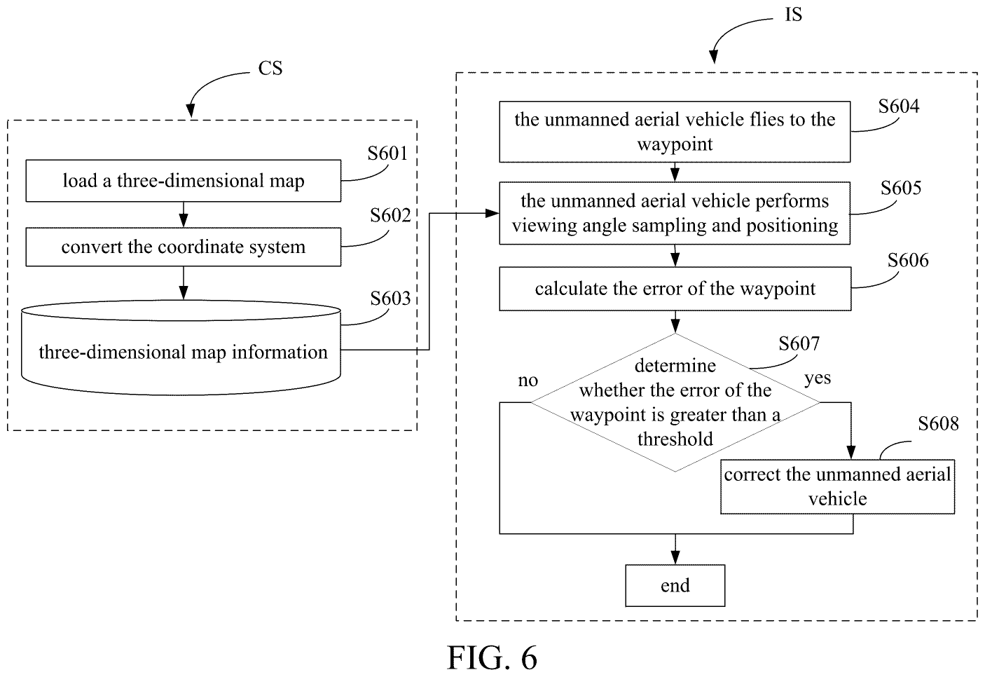

For easier understanding, please refer to the operation diagram in FIG. 6. The operation of the present disclosure can be divided into a calibration phase and an inspection phase (e.g., the calibration phase CS and the inspection phase IS in FIG. 6). First, in the calibration phase CS, the waypoint correction device WCD executes the operation S601 to load a three-dimensional map. Next, the waypoint correction device WCD executes the operation S602 and the operation S603 to convert the virtual coordinate system (i.e., the mapping coordinate system) to the real world coordinate system (i.e., the world coordinate system) and outputs the three-dimensional map information as the basic map during the operation of the inspection phase IS.

After completing the calibration phase CS, the waypoint correction device WCD performs the operation S604 to control the unmanned aerial vehicle UAV to fly to the waypoint. Next, the waypoint correction device WCD executes the operation S605 to control the unmanned aerial vehicle UAV to perform viewing angle sampling and positioning. Next, the waypoint correction device WCD performs the operation S606 to calculate the error of the waypoint.

Next, the waypoint correction device WCD executes the operation S607 to determine whether the error of the waypoint is greater than a threshold. If the result is yes, the operation 608 is executed to correct the unmanned aerial vehicle UAV. If the result is no, then the operation will be ended.

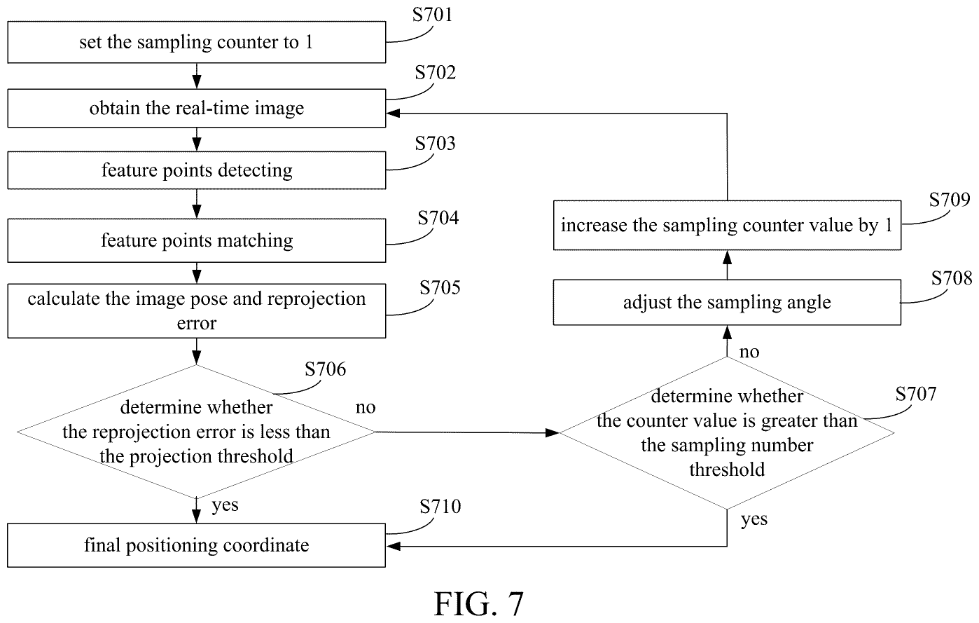

For easier understanding, please refer to the correction operation diagram in FIG. 7. First, the waypoint correction device WCD executes the operation S701 to set the sampling counter to 1. Next, the waypoint correction device WCD executes the operation S702, the operation S703, and the operation S704 to obtain feature point matching of the real-time image. Next, the waypoint correction device WCD performs the operation S705 to calculate the image pose and reprojection error.

Next, the waypoint correction device WCD executes the operation S706 to determine whether the reprojection error is less than the projection threshold. If the result is yes, the waypoint correction device WCD executes the operation S710 to calculate the final positioning coordinates. If the result is no, the waypoint correction device WCD performs the operation S707 to determine whether the counter value is greater than the sampling number threshold. If the result is yes, the waypoint correction device WCD executes the operation S710 to calculate the final positioning coordinates.

If the result is no, the waypoint correction device WCD executes the operation S708 and the operation S709 to adjust the sampling angle and increase the sampling counter value by 1, and executes the operation S702 again to re-correct the waypoint.

According to the above descriptions, the waypoint correction device WCD provided by the present disclosure controls the unmanned aerial vehicle to adjust the viewing angle to capture more and more accurate real-time images with more feature points by actively analyzing the distribution of feature points of real-time images. Next, the waypoint correction device WCD provided by the present disclosure can generate a corrected route based on the pre-stored three-dimensional feature points and the adjusted real-time image to control the unmanned aerial vehicle to move to the correct predetermined waypoint based on the corrected route. In addition, the waypoint correction device WCD provided by the present disclosure can further consider the sampling times, and when the result of the projection error value is not good, the viewing angle is adjusted again to capture a new real-time image for judgment. Since the waypoint correction device WCD provided by the present disclosure can perform waypoint correction of unmanned aerial vehicles through visual positioning, and does not require the configuration of expensive modules, it solves the shortcomings of conventional technologies.

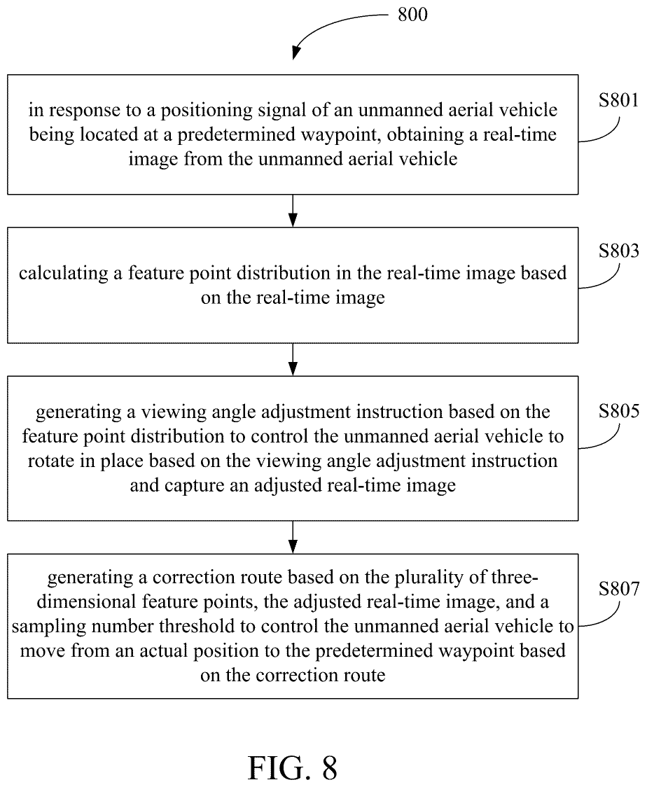

A second embodiment of the present disclosure is a waypoint correction method and a flowchart thereof is depicted in FIG. 8. The waypoint correction method 800 is adapted for an electronic device (e.g., the waypoint correction device WCD of the first embodiment). The electronic device stores a three-dimensional map, and the three-dimensional map comprises a plurality of three-dimensional feature points. The waypoint correction method 800 generates a correction route through steps S801 to S807.

In the step S801, in response to a positioning signal of an unmanned aerial vehicle being located at a predetermined waypoint, the electronic device obtains a real-time image from the unmanned aerial vehicle. Next, in the step S803, the electronic device calculates a feature point distribution in the real-time image based on the real-time image.

Then, in step S805, the electronic device generates a viewing angle adjustment instruction based on the feature point distribution to control the unmanned aerial vehicle to rotate in place based on the viewing angle adjustment instruction and capture an adjusted real-time image.

Finally, in the step S807, the electronic device generates a correction route based on the plurality of three-dimensional feature points, the adjusted real-time image, and a sampling number threshold to control the unmanned aerial vehicle to move from an actual position to the predetermined waypoint based on the correction route.

In some embodiments, the step of generating the viewing angle adjustment instruction comprises the following steps: selecting a first region having a maximum number of feature points from a plurality of regions in the real-time image based on the feature point distribution; and generating the viewing angle adjustment instruction based on the first region.

In some embodiments, the step of generating the correction route comprises the following steps: in response to obtaining the adjusted real-time image from the unmanned aerial vehicle, performing a feature point matching operation based on the adjusted real-time image and the three-dimensional feature points of the three-dimensional map to generate a plurality of first feature point pairs and a first projection error value corresponding to the adjusted real-time image; in response to the first projection error value being lower than a projection threshold or a resampling number being greater than the sampling number threshold, calculating the actual position of the unmanned aerial vehicle based on the first feature point pairs; and generating the correction route based on the actual position, wherein the processor controls the unmanned aerial vehicle to move from the actual position to the predetermined waypoint based on the correction route.

In some embodiments, wherein the feature point matching operation comprises the following steps: calculating a plurality of plane feature points in the adjusted real-time image; and comparing the plurality of plane feature points and the three-dimensional feature points to generate the first feature point pairs, wherein each of the first feature point pairs comprises one of the plane feature points and one of the three-dimensional feature points.

In some embodiments, the step of generating the first projection error value comprises the following steps: calculating a transfer matrix based on the three-dimensional feature points in the first feature point pairs and the corresponding plurality of plane feature points, wherein the transfer matrix is configured to transfer a three-dimensional coordinate in the three-dimensional map to one of a plurality of plane coordinates in the adjusted real-time image; transferring the three-dimensional feature points to the plane coordinates of the adjusted real-time image based on the transfer matrix to generate a plurality of reprojection coordinates; and comparing the reprojection coordinates and the plane feature points to generate the first projection error value.

In some embodiments, the waypoint correction method 800 further comprises the following steps: in response to the first projection error value being higher than the projection threshold and the resampling number being lower than the sampling number threshold, generating a new view angle adjustment instruction based on the feature point distribution of the adjusted real-time image to control the unmanned aerial vehicle to rotate in place based on the new view angle adjustment instruction and to capture the adjusted real-time image again.

In some embodiments, the waypoint correction method 800 further comprises the following steps: generating a plurality of second feature point pairs and a second projection error value corresponding to the adjusted real-time image; and in response to the second projection error value being lower than the projection threshold or the resampling number being greater than the sampling number threshold, calculating the actual position of the unmanned aerial vehicle based on the second feature point pairs, and not generating the viewing angle adjustment instruction.

In some embodiments, the waypoint correction method 800 further comprises the following steps: in response to a signal strength of the positioning signal being lower than a strength threshold, generating a control signal, wherein the control signal is configured to control the unmanned aerial vehicle to increase a capture frequency of capturing the real-time image, and the processor increases a receiving frequency of obtaining the real-time image from the unmanned aerial vehicle.

In some embodiments, the waypoint correction method 800 further comprises the following steps: in response to a distance of the predetermined waypoint and a target object being less than a distance threshold, generating a control signal, wherein the control signal is configured to control the unmanned aerial vehicle to increase a capture frequency of capturing the real-time image, and the processor increases a receiving frequency of obtaining the real-time image from the unmanned aerial vehicle.

In some embodiments, the electronic device further comprises a user interface, the user interface is configured to receive a flag value corresponding to the predetermined waypoint, and the waypoint correction method 800 further comprises the following steps: in response to the positioning signal of the unmanned aerial vehicle being located at the predetermined waypoint, determining whether to generate a control signal based on the flag value, wherein the control signal is configured to control the unmanned aerial vehicle to capture the real-time image.

In addition to the aforesaid steps, the second embodiment can also execute all the operations and steps of the waypoint correction device WCD set forth in the first embodiment, have the same functions, and deliver the same technical effects as the first embodiment and the second embodiment. How the second embodiment executes these operations and steps, has the same functions, and delivers the same technical effects will be readily appreciated by those of ordinary skill in the art based on the explanation of the first embodiment. Therefore, the details will not be repeated herein.

Next, the third embodiment of the present disclosure will be described in detail below. In short, in addition to the operations performed in the first embodiment and the second embodiment, in the third embodiment, the waypoint correction device WCD (or the waypoint correction device disposed in the unmanned aerial vehicle UAV) may further comprise a user interface.

Specifically, the user interface is configured to provide a user to control an unmanned aerial vehicle (UAV), wherein the user interface comprises a waypoint correction function activation option. For example, the waypoint correction function activation option of the user interface may further comprise customized settings of various thresholds, such as sampling number threshold, distance threshold, projection threshold, intensity threshold, etc.

In addition, in the present embodiment, the waypoint correction device WCD obtains a real-time image from the unmanned aerial vehicle UAV in response to an activation state of the waypoint correction function activation option. It shall be appreciated that in the present embodiment, the waypoint correction device WCD can execute the waypoint correction operation executed in the first embodiment and the second embodiment.

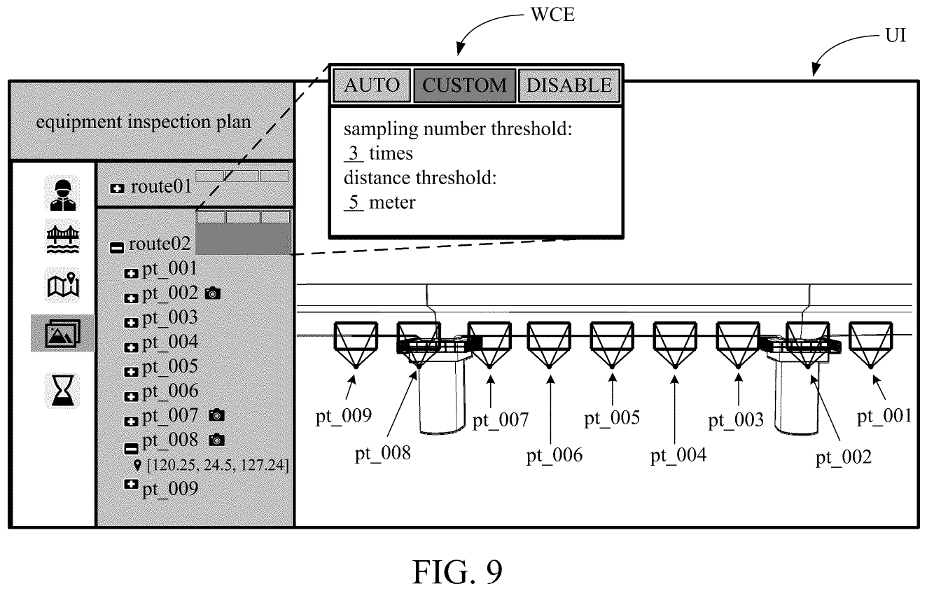

For easier understanding, please refer to FIG. 9. As shown in FIG. 9, the user interface UI may comprise various setting interfaces and information presentation pages in the equipment inspection plan, such as the waypoint correction function activation option WCE (Waypoint Correction Enablement), route setting options, and multiple scheduled waypoints included in the route.

In the present example, the route 02 comprises the scheduled waypoints pt_001, pt_002, pt_003, pt_004, pt_005, pt_006, pt_007, pt_008, and pt_009, and each scheduled waypoint comprises the relevant information of the waypoint, such as: longitude and latitude data.

Users can set whether the waypoint correction function corresponding to different routes is enabled through the user interface UI. For example, in the present example, the route 01 and the route 02 each have their own waypoint correction function activation options WCE. The user can use these waypoint correction function activation options WCE to set the waypoint correction function of the route 01 and the route 02 respectively.

The waypoint correction function activation option WCE may further comprise an activation state setting option. For example, in the present example, the waypoint correction function activation option WCE further comprises three options “waypoint correction function activation (System Default)”, “waypoint correction function activation (User-defined)”, and “waypoint correction function turned off”. In the present example, the option “waypoint correction function activation (System Default)” will turn on the waypoint correction function, and the sampling number threshold and distance threshold will be automatically set by the waypoint correction device WCD; the option “waypoint correction function activation (User-defined)” will also enable the waypoint correction function, but allow users to set the sampling number threshold and distance threshold by themselves; The option “waypoint correction function turned off” will turn off the waypoint correction function. Under such a design, it is helpful for users to set different waypoint correction function plans for different routes, further improving the safety of unmanned aerial vehicles during inspections.

According to the above descriptions, the waypoint correction technology (at least including the device and the method) provided by the present disclosure controls the unmanned aerial vehicle to adjust the viewing angle to capture more and more accurate real-time images with more feature points by actively analyzing the distribution of feature points of real-time images. Next, the waypoint correction technology provided by the present disclosure can generate a corrected route based on the pre-stored three-dimensional feature points and the adjusted real-time image to control the unmanned aerial vehicle to move to the correct predetermined waypoint based on the corrected route. In addition, the waypoint correction technology provided by the present disclosure can further consider the sampling times, and when the result of the projection error value is not good, the viewing angle is adjusted again to capture a new real-time image for judgment. Since the waypoint correction technology provided by the present disclosure can perform waypoint correction of unmanned aerial vehicles through visual positioning, and does not require the configuration of expensive modules, it solves the shortcomings of conventional technologies.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A waypoint correction device, comprising:
a storage, being configured to store a three-dimensional map, wherein the three-dimensional map comprises a plurality of three-dimensional feature points; and
a processor, being electrically connected to the storage, and being configured to perform operations comprising:
in response to a positioning signal of an unmanned aerial vehicle being located at a predetermined waypoint, obtaining a real-time image from the unmanned aerial vehicle;
calculating a feature point distribution in the real-time image based on the real-time image;
generating a viewing angle adjustment instruction based on the feature point distribution to control the unmanned aerial vehicle to rotate in place based on the viewing angle adjustment instruction and capture an adjusted real-time image; and
generating a correction route based on the plurality of three-dimensional feature points, the adjusted real-time image, and a sampling number threshold to control the unmanned aerial vehicle to move from an actual position to the predetermined waypoint based on the correction route.

2. The waypoint correction device of claim 1, wherein the operation of generating the viewing angle adjustment instruction comprises the following operations:
selecting a first region having a maximum number of feature points from a plurality of regions in the real-time image based on the feature point distribution; and
generating the viewing angle adjustment instruction based on the first region.

3. The waypoint correction device of claim 2, wherein the operation of generating the correction route comprises the following operations:
in response to obtaining the adjusted real-time image from the unmanned aerial vehicle, performing a feature point matching operation based on the adjusted real-time image and the three-dimensional feature points of the three-dimensional map to generate a plurality of first feature point pairs and a first projection error value corresponding to the adjusted real-time image;
in response to the first projection error value being lower than a projection threshold or a resampling number being greater than the sampling number threshold, calculating the actual position of the unmanned aerial vehicle based on the plurality of first feature point pairs; and
generating the correction route based on the actual position, wherein the processor controls the unmanned aerial vehicle to move from the actual position to the predetermined waypoint based on the correction route.

4. The waypoint correction device of claim 3, wherein the feature point matching operation comprises the following operations:
calculating a plurality of plane feature points in the adjusted real-time image; and
comparing the plurality of plane feature points and the plurality of three-dimensional feature points to generate the plurality of first feature point pairs, wherein each of the plurality of first feature point pairs comprises one of the plurality of plane feature points and one of the plurality of three-dimensional feature points.

5. The waypoint correction device of claim 3, wherein the operation of generating the first projection error value comprises the following operations:
calculating a transfer matrix based on the plurality of three-dimensional feature points in the plurality of first feature point pairs and a plurality of corresponding plane feature points, wherein the transfer matrix is configured to transfer a three-dimensional coordinate in the three-dimensional map to one of a plurality of plane coordinates in the adjusted real-time image;
transferring the plurality of three-dimensional feature points to the plurality of plane coordinates of the adjusted real-time image based on the transfer matrix to generate a plurality of reprojection coordinates; and
comparing the plurality of reprojection coordinates and the plurality of corresponding plane feature points to generate the first projection error value.

6. The waypoint correction device of claim 3, wherein the processor is further configured to perform the following operations:
in response to the first projection error value being higher than the projection threshold and the resampling number being lower than the sampling number threshold, generating a new view angle adjustment instruction based on the feature point distribution of the adjusted real-time image to control the unmanned aerial vehicle to rotate in place based on the new view angle adjustment instruction and to capture the adjusted real-time image again.

7. The waypoint correction device of claim 6, wherein the processor is further configured to perform the following operations:
generating a plurality of second feature point pairs and a second projection error value corresponding to the adjusted real-time image; and
in response to the second projection error value being lower than the projection threshold or the resampling number being greater than the sampling number threshold, calculating the actual position of the unmanned aerial vehicle based on the plurality of second feature point pairs, and not generating the viewing angle adjustment instruction.

8. The waypoint correction device of claim 1, wherein the processor is further configured to perform the following operations:
in response to a signal strength of the positioning signal being lower than a strength threshold, generating a control signal, wherein the control signal is configured to control the unmanned aerial vehicle to increase a capture frequency of capturing the real-time image, and the processor increases a receiving frequency of obtaining the real-time image from the unmanned aerial vehicle.

9. The waypoint correction device of claim 1, wherein the processor is further configured to perform the following operations:
in response to a distance of the predetermined waypoint and a target object being less than a distance threshold, generating a control signal, wherein the control signal is configured to control the unmanned aerial vehicle to increase a capture frequency of capturing the real-time image, and the processor increases a receiving frequency of obtaining the real-time image from the unmanned aerial vehicle.

10. A waypoint correction method, being adapted for use in an electronic device, wherein the electronic device stores a three-dimensional map, the three-dimensional map comprises a plurality of three-dimensional feature points, and the waypoint correction method comprises the following steps:
in response to a positioning signal of an unmanned aerial vehicle being located at a predetermined waypoint, obtaining a real-time image from the unmanned aerial vehicle;
calculating a feature point distribution in the real-time image based on the real-time image;
generating a viewing angle adjustment instruction based on the feature point distribution to control the unmanned aerial vehicle to rotate in place based on the viewing angle adjustment instruction and capture an adjusted real-time image; and
generating a correction route based on the plurality of three-dimensional feature points, the adjusted real-time image, and a sampling number threshold to control the unmanned aerial vehicle to move from an actual position to the predetermined waypoint based on the correction route.

11. The waypoint correction method of claim 10, wherein the step of generating the viewing angle adjustment instruction comprises the following steps:
selecting a first region having a maximum number of feature points from a plurality of regions in the real-time image based on the feature point distribution; and
generating the viewing angle adjustment instruction based on the first region.

12. The waypoint correction method of claim 11, wherein the step of generating the correction route comprises the following steps:
in response to obtaining the adjusted real-time image from the unmanned aerial vehicle, performing a feature point matching operation based on the adjusted real-time image and the plurality of three-dimensional feature points of the three-dimensional map to generate a plurality of first feature point pairs and a first projection error value corresponding to the adjusted real-time image;
in response to the first projection error value being lower than a projection threshold or a resampling number being greater than the sampling number threshold, calculating the actual position of the unmanned aerial vehicle based on the plurality of first feature point pairs; and
generating the correction route based on the actual position, wherein the electronic device controls the unmanned aerial vehicle to move from the actual position to the predetermined waypoint based on the correction route.

13. The waypoint correction method of claim 12, wherein the feature point matching operation comprises the following steps:
calculating a plurality of plane feature points in the adjusted real-time image; and
comparing the plurality of plane feature points and the plurality of three-dimensional feature points to generate the plurality of first feature point pairs, wherein each of the plurality of first feature point pairs comprises one of the plurality of plane feature points and one of the plurality of three-dimensional feature points.

14. The waypoint correction method of claim 12, wherein the step of generating the first projection error value comprises the following steps:
calculating a transfer matrix based on the plurality of three-dimensional feature points in the plurality of first feature point pairs and a plurality of corresponding plane feature points, wherein the transfer matrix is configured to transfer a three-dimensional coordinate in the three-dimensional map to one of a plurality of plane coordinates in the adjusted real-time image;
transferring the plurality of three-dimensional feature points to the plurality of plane coordinates of the adjusted real-time image based on the transfer matrix to generate a plurality of reprojection coordinates; and
comparing the plurality of reprojection coordinates and the plurality of corresponding plane feature points to generate the first projection error value.

15. The waypoint correction method of claim 12, wherein the waypoint correction method further comprises the following steps:
in response to the first projection error value being higher than the projection threshold and the resampling number being lower than the sampling number threshold, generating a new adjustment view angle based on the feature point distribution of the adjusted real-time image to control the unmanned aerial vehicle to capture the adjusted real-time image again based on the new adjustment view angle.

16. The waypoint correction method of claim 15, wherein the waypoint correction method further comprises the following steps:
generating a plurality of second feature point pairs and a second projection error value corresponding to the adjusted real-time image; and
in response to the second projection error value being lower than the projection threshold or the resampling number being greater than the sampling number threshold, calculating the actual position of the unmanned aerial vehicle based on the plurality of second feature point pairs, and not generating the viewing angle adjustment instruction.

17. The waypoint correction method of claim 10, wherein the waypoint correction method further comprises the following steps:
in response to a signal strength of the positioning signal being lower than a strength threshold, generating a control signal, wherein the control signal is configured to control the unmanned aerial vehicle to increase a capture frequency of capturing the real-time image, and the electronic device increases a receiving frequency of obtaining the real-time image from the unmanned aerial vehicle.

18. The waypoint correction method of claim 10, wherein the waypoint correction method further comprises the following steps:
in response to a distance of the predetermined waypoint and a target object being less than a distance threshold, generating a control signal, wherein the control signal is configured to control the unmanned aerial vehicle to increase a capture frequency of capturing the real-time image, and the electronic device increases a receiving frequency of obtaining the real-time image from the unmanned aerial vehicle.

19. The waypoint correction method of claim 10, wherein the electronic device further comprises a user interface, the user interface is configured to receive a flag value corresponding to the predetermined waypoint, and the waypoint correction method further comprises the following steps:
in response to the positioning signal of the unmanned aerial vehicle being located at the predetermined waypoint, determining whether to generate a control signal based on the flag value, wherein the control signal is configured to control the unmanned aerial vehicle to capture the real-time image.

20. A waypoint correction device, comprising:
a storage, being configured to store a three-dimensional map, wherein the three-dimensional map comprises a plurality of three-dimensional feature points;
an user interface, being configured to provide a user with control over an unmanned aerial vehicle, wherein the user interface comprises a waypoint correction function activation option; and
a processor, being electrically connected to the storage and the user interface, and being configured to perform operations comprising:
in response to an activation state of the waypoint correction function activation option, obtaining a real-time image from the unmanned aerial vehicle;
generating a viewing angle adjustment instruction based on the real-time image to control the unmanned aerial vehicle to rotate in place based on the viewing angle adjustment instruction, and capturing an adjusted real-time image; and
generating a correction route based on the adjusted real-time image to control the unmanned aerial vehicle to move from the actual position to a predetermined waypoint based on the correction route.
